(19) United States
(12) Patent Application Publication
(10) Pub. No.: US 2026/0200502 A1
(43) Pub. Date: Jul. 16, 2026

(54) World Model Lane Change Prediction

(71) Applicant: Nissan North America, Inc., Frenklin, TN (US)

(72) Inventors: Manh Huynh, Sunnyvale, CA (US); Huiching Chen, San Jose, CA (US); Qizhan Tam, San Jose, CA (US); Christopher Ostafew, Mountain View, CA (US)

(21) Appl. No.: 19/022,487

(22) Filed: Jan. 15, 2025

(51) Int. Cl. B60W 60/00; B60W 30/18; B60W 50/00

(52) U.S. Cl. CPC B60W 60/00274; B60W 30/18154; B60W 50/0097; B60W 60/0015; B60W 2552/30; B60W 2554/4045; B60W 2554/80; B60W 2556/10; B60W 2556/20

(57) ABSTRACT

A method of tracking an object of interest within a vehicle transportation network. Monitoring lane change considerations related to the object of interest as the object of interest travels through the vehicle transportation network. Predicting a likelihood that the object of interest changes lanes as the object of interest travels within the vehicle transportation network. Controlling an autonomous vehicle (AV) adjacent to the object of interest to take corrective action if the AV determines that the object of interest is likely to change lanes.

### TECHNICAL FIELD

This application relates to predicting a lane change of a vehicle from an adjacent lane to a location in front of an autonomous vehicle.

### BACKGROUND

For safe and reliable operation, at least some sub-systems in a vehicle may include inherent self-monitoring capabilities, issue detection capabilities, and, if possible, remediation capabilities.

Autonomous vehicles (or more broadly, autonomous driving) offer passengers the convenience of efficient and safe conveyance from one location to another. An autonomous vehicle may plan a trajectory to traverse a portion of a vehicle transportation network based on lane level maps in the absence of real-time perception information of the portion of the vehicle transportation network. Additionally, the autonomous vehicles may track a position of surrounding vehicles within the network.

### SUMMARY

Building an accurate lane-level map is expensive and time-consuming. A lane-level map may be formed by estimating geometric center lines relative to lane markings. However, a lane-level map defined by geometric center lines may not represent how people actually drive. However, the system may track how vehicles controlled by people are driven so that additional data points may be generated relative to a road structure and lanes within that road structure. The system may further track how vehicles controlled by people move within the lanes of the road structure. The system may smooth curves or drivelines related to moving through an intersection or turning while driving through an intersection.

The teachings herein describe combining a road-level map and observed drivelines of real-world road users to generate a data-based driveline map in lane-level detail. Such a map may be used for improved determination of a vehicle trajectory and improved operation of a vehicle. The road structures may be modeled based on empirical data, maps, user input, multiple vehicles, multiple data inputs (e.g., sources), or a combination thereof.

A first aspect of the teachings herein provides a method including tracking an object of interest within a vehicle transportation network. Monitoring lane change considerations related to the object of interest as the object of interest travels through the vehicle transportation network. Predicting a likelihood that the object of interest changes lanes as the object of interest travels within the vehicle transportation network. Controlling an autonomous vehicle (AV) adjacent to the object of interest to take corrective action based upon a probability that the object of interest is going to change lanes

A second aspect of the teachings herein provide an apparatus including: a memory; and a processor configured to execute instructions stored in the memory. The instructions are configured to: track an object traveling within a vehicle transportation network. Monitor lane change considerations related to the object of interest as the object of interest travels through the vehicle transportation network. Predict a likelihood that the object of interest changes lanes as the object of interest travels within the vehicle transportation network. Control an autonomous vehicle (AV) adjacent to the object of interest to take corrective action based upon a probability that the object of interest is going to change lanes

A third aspect of the teachings herein provide a non-transitory computer-readable medium storing instructions operable to cause one or more processors to perform operations to: track an object traveling within a vehicle transportation network. Monitor lane change considerations related to the object of interest as the object of interest travels through the vehicle transportation network. Predict a likelihood that the object of interest changes lanes as the object of interest travels within the vehicle transportation network. Control an autonomous vehicle (AV) adjacent to the object of interest to take corrective action based upon a probability that the object of interest is going to change lanes

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3A are diagrams showing examples of a road-level map.

FIG. 3B is a diagram showing an example of observed drivelines in a portion of a vehicle transportation network.

FIG. 3C is a diagram showing an example of observed drivelines and ways in a portion of a vehicle transportation network.

FIG. 4A illustrates a scenario where an adjacent vehicle may change lanes into a lane of an autonomous vehicle.

FIG. 4B illustrates a scenario where an adjacent vehicle may change lanes into a lane of an autonomous vehicle.

FIG. 4C illustrates a scenario where an adjacent vehicle may change lanes across a lane of an autonomous vehicle.

FIG. 4D illustrates a scenario where adjacent vehicles may change lanes as an autonomous vehicle turns into another lane.

FIG. 4E illustrates a scenario where multiple vehicles are adjacent to the autonomous vehicle and the autonomous vehicle determines a likelihood that the vehicle may change lanes.

FIG. 5 is a diagram of a world prediction model.

FIG. 6 is a diagram of predicting a lane change model with the world predicted model.

FIG. 7 is a flow diagram of generating a lane change estimation.

FIG. 8 is a flow diagram of generating a lane change likelihood estimation.

### DETAILED DESCRIPTION

A vehicle (which may also be referred to herein as a host vehicle), such as an autonomous vehicle (AV) or a semi-autonomous vehicle, such as a vehicle including an advanced driver-assistance system (ADAS), may autonomously traverse a portion of a vehicle transportation network. Collectively, such vehicles may be referred to as autonomous vehicles.

Traversing the vehicle transportation network may include capturing data, such as data corresponding to an operational environment of the vehicle, or a portion thereof. For example, the data may include data corresponding to one or more external objects (or simply, objects) including other road users (i.e., other than the host vehicle itself), such as other vehicles, bicycles, motorcycles, trucks, etc., that may also be traversing the vehicle transportation network.

A trajectory can be planned (such as by a controller of the host vehicle) based on scene understanding. A scene can include the external objects (e.g., the other road users) around of the host vehicle, including static and dynamic objects. A scene can include data available in a road-level map. The road-level map can include way data. Way data can be one or more ways where a way can be a line of a lane such that a longitudinal axis of a road user traversing the lane can be expected to align with the way. The way can also contain nodes in which each node makes up a point along the way.

Additionally, a scene can also include observed driveline data of at least some of the other road users. The observed driveline data includes one or more drivelines. The drivelines represent the line in which a road user was recorded as having travelled while traversing the vehicle transportation network. The drivelines comprise a series of poses where a pose represents the specific location along the driveline including the direction the road user was heading at the time the pose was recorded. As such, scene understanding can include way data available in road-level maps and observed driveline data of other road users.

Poor or inaccurate lane-level maps may cause the controller of the vehicle to plan sub-optimal or unsafe trajectories for the host vehicle. Inaccurate lane-level maps may occur in several situations. For example, inaccurate lane-level maps may occur when the data in the road-level map is inaccurate or incomplete. For example, inaccurate lane-level maps may occur if the data in the road-level map is accurate, but road users may drive in ways that are not according to the data in the road-level map.

To illustrate, and without loss of generality, a left-turn driveline at an intersection may be accurately mapped; however, a majority of road users may drive past the mapped driveline before turning left at the interaction. It is noted that there can be a wide variance on how drivers make the turn (or confront any other driving situation or driveline). The system may analyze multiple data sources in regards to a turn and may provide a drive line with a width that is increased relative to a typical drive line so that variations in turning locations may be taken into consideration to provide a turning region.

The present teachings relate to an autonomous vehicle (AV) that predicts lane changes of adjacent vehicles and then takes corrective actions based upon this prediction. A processor may monitor a plurality of lane change considerations to determine if an adjacent vehicle is probable (e.g., likely) to change lanes. The probability of changing lanes may be some number between 0 and a 100 (e.g., 0 percent (not likely) and 100 percent (highly likely)). Based on the probability (e.g., predicted number), the corrective actions may vary. If the predicted number is low (e.g., 25 or less) than no corrective action may occur. If the predicted number is a low to medium number (e.g., 25 to 50) than some corrective action may begin to occur such as slowing down, speeding up, changing lanes, or a combination thereof. If the predicted number is a medium to high number (e.g., 50 to 75) than a corrective action taken may be more aggressive than the corrective action taken if the predicted number is low to medium. For example, the AV may change speeds at a faster rate than when the predicted number is a low to medium number. Finally, if the predicted number is a high number (e.g., over 75) than the AV may aggressively take corrective actions or may implement two or more corrective actions so that the AV compensates for the object of interest changing lanes.

The processor may track one or more objects of interests based upon a world model prediction, relative pose estimations, and lane change likelihood estimations based upon the lane change considerations. The lane change considerations may include tracking turn signals, distances to parked vehicles, historical lateral motions, lane curvatures, kinematic predictions, or a combination thereof. The present teaches may use a lane change prediction that tracks objects via a world model prediction. Based upon the probably (e.g., predicted number) the processor may generate proactive planning, reactive planning, or both that generate one or more corrective actions.

Although described herein with reference to an autonomous host vehicle, the techniques and apparatuses described herein may be implemented in any vehicle capable of autonomous or semi-autonomous operation. The method and apparatus described herein may be used within a vehicle transportation network, which can include any area navigable by a host vehicle.

To describe some implementations of the teachings herein in greater detail, reference is first made to the environment in which this disclosure may be implemented.

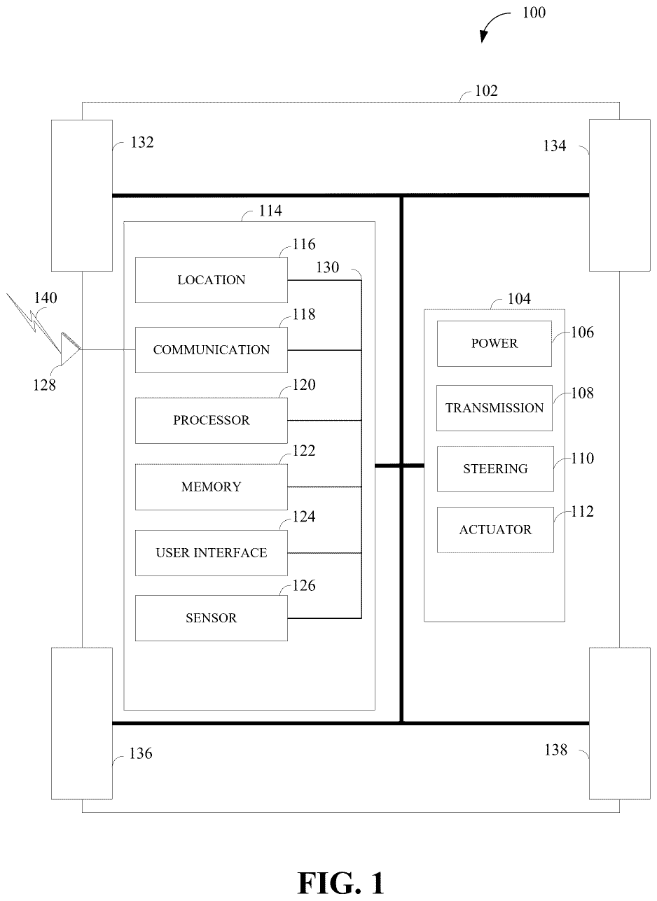

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/ 136/138, and may include any other element or combination of elements of a vehicle. Although the vehicle 100 is shown as including four wheels 132/134/ 136/138 for simplicity, any other propulsion device or devices, such as a propeller or tread, may be used. In FIG. 1, the lines interconnecting elements, such as the powertrain 104, the controller 114, and the wheels 132/134/ 136/138, indicate that information, such as data or control signals, power, such as electrical power or torque, or both information and power, may be communicated between the respective elements. For example, the controller 114 may receive power from the powertrain 104 and communicate with the powertrain 104, the wheels 132/134/ 136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/ 136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and the power source 106 is operative to provide kinetic energy as a motive force to one or more of the wheels 132/134/ 136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/ 136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/ 136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

The processor 120 may include any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/ 136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/ 136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

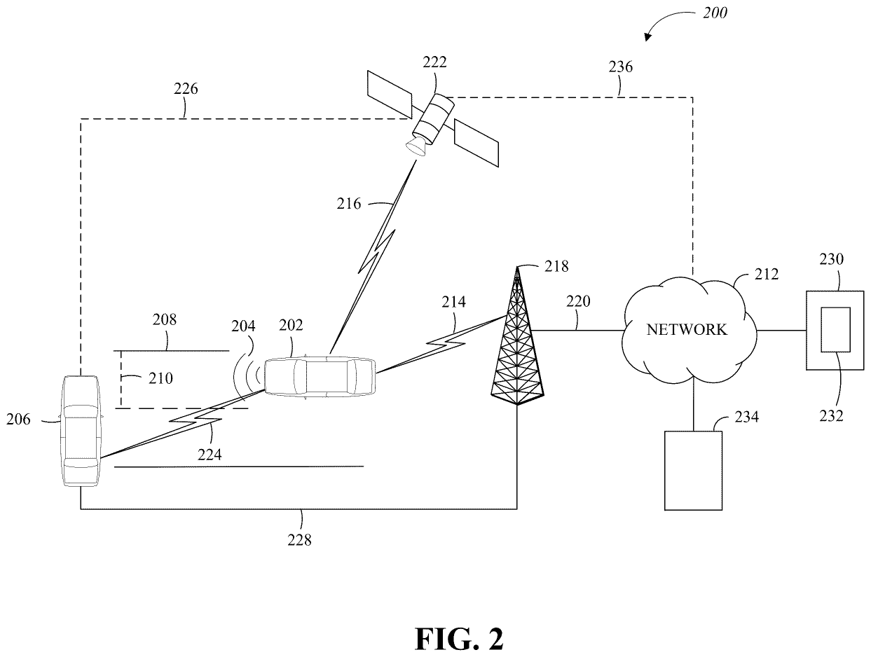

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208 and may communicate with the external object 206 via one or more of an electronic communication network 212. Although not explicitly shown in FIG. 2, a vehicle may traverse an area that is not expressly or completely included in a transportation network, such as an off-road area. The transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

The vehicle 202 or the external object 206 may communicate via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

The vehicle 202 may communicate with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

As mentioned initially, observed drivelines may be used together with available (e.g., road-level) map data to create data-based driveline maps with lane-level details. Next described are the data used to create a data-based driveline map and a process or method for creating and using a data-based driveline map.

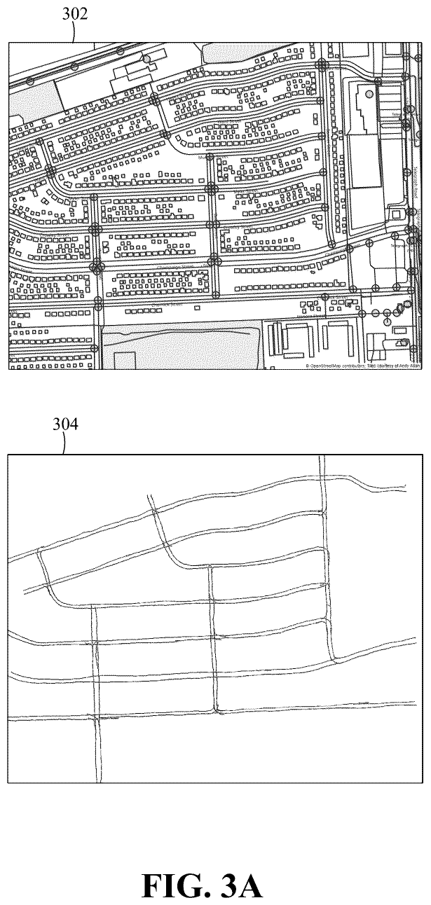

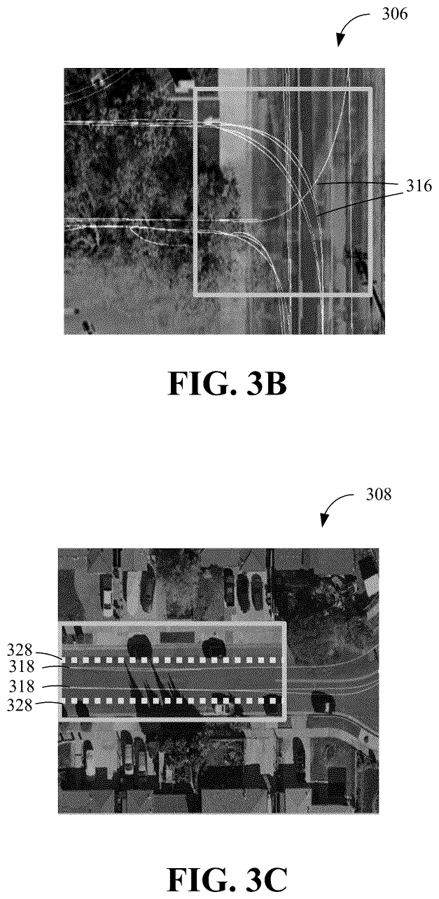

FIG. 3A shows examples of map data in accordance with the present disclosure. An example of road-level map data is shown. The road-level map data depicts a portion 302 of a mapped area. In the road-level map data, the roads 304 are mapped at the road level. In the portion 302, however, lane-level mapping based on geometric centerlines is shown for illustrative purposes.

FIG. 3B is a diagram showing an example of observed drivelines in a portion 306 of a vehicle transportation network, and FIG. 3C is a diagram showing an example of observed drivelines 316 and ways in a portion 306 of a vehicle transportation network.

In FIG. 3B, the portion 306 illustrates drivelines 316 of multiple observed vehicles, such as the vehicle 202 of FIG. 2, collected while the vehicles were making turns within the vehicle transportation network. A driveline contains a series of poses, where a pose represents a specific point location and heading of the vehicle as the vehicle was traversing the vehicle transportation network. Driveline data includes one or more drivelines.

In FIG. 3C, a portion 308 illustrates drivelines 318 of multiple observed vehicles, such as the vehicle 202 of FIG. 2, collected while the vehicles are driving along a residential street within the vehicle transportation network. Road-level map data includes way data, the way data containing one or more ways. A way represents a lane or a road. Each way contains a series of nodes in which each node represents a specific point location and heading of the way. The example of FIG. 3C shows a bi-directional way without lane markings. Points 328 in FIG. 3C are shown at the geometric centerline for each direction of travel. As can be seen from comparing the drivelines 318 to the points 328, drivers rarely drive on the geometric centerline for each direction.

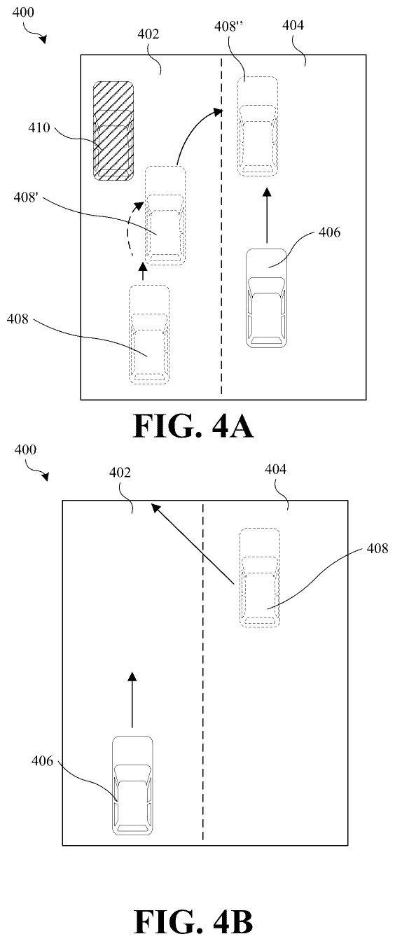

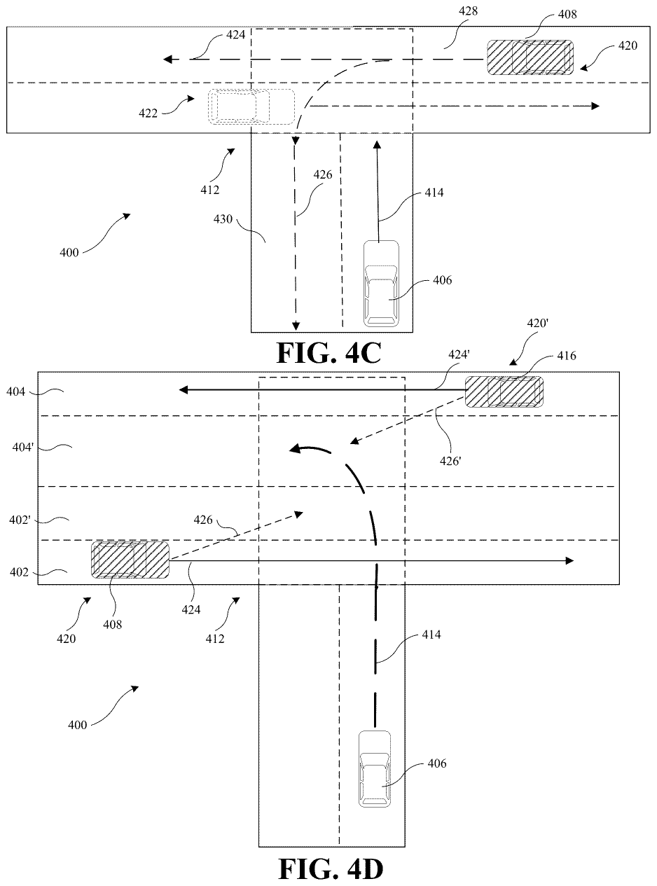

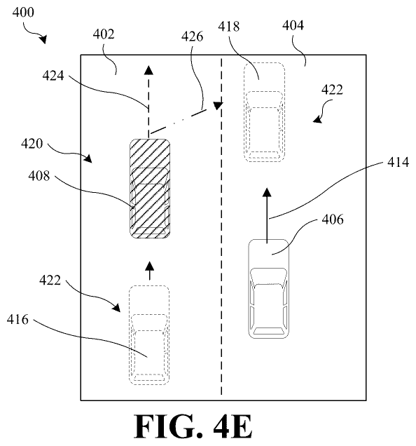

FIGS. 4A-4E illustrate various lane change scenarios. In response to each lane change scenario an autonomous vehicle (AV) may identify other vehicles that are lane change candidates and may track movements of those vehicles such that a probability of vehicle changing lanes may be determined so that the AV may avoid crossing paths (e.g., colliding) with the vehicle. The AV may identify vehicles or objects that are not a lane change candidate, and those vehicles or objects may be eliminated from consideration. By eliminating vehicles from consideration, higher consideration may be provided to the objects of interest; thus, providing a higher degree of certainty and speed of computation versus analyzing every object or vehicle.

FIG. 4A illustrates a scenario with a roadway 400 having a left-hand lane 402 and a right-hand lane 404. An autonomous vehicle 406 is traveling in the right-hand lane 404, and a second vehicle 408 is traveling within the left-hand lane 402. A parked vehicle 410 is located partially within the left-hand lane 402 such that the second vehicle 408 may move over in the left-hand lane 402 or may change lanes into the right-hand lane 404. The autonomous vehicle 406, based upon this scenario, will assess lane change considerations to determine an appropriate action. The lane change considerations may include one or more of turn signal use, parked vehicles in an adjacent area, movements of adjacent vehicles, a heading of the adjacent vehicles, speed of adjacent vehicles, upcoming lane path changes, location of the adjacent vehicles to the autonomous vehicle (AV) 406, projected path of the AV 406, kinematic predictions, or a combination thereof. The AV 406 based on one or more lane change considers assess the likelihood that the second vehicle 408 will move over within the left-hand lane 402 to a position of the second vehicle 408′ or if the position will be a lane change to a lane change position of the second vehicle 408″. Based upon the lane change considerations the AV 406 may take a corrective action such as slowing down, changing lanes, speeding up, moving over, stopping speeding up, stopping maintaining a speed, coasting, braking, following distance, or a combination thereof. Thus, in the present scenario, the AV 406 (or processor of the AV) may generate a high likelihood (e.g., predicted number or percentage of about 75 or greater) that the second vehicle 408 will change lanes, or will move within the left-handed lane 402 toward and possibly even into the right-hand lane 404 due to the parked vehicle 410. Thus, the AV 406 may take a corrective action such as to cease speeding up and/or begin to brake as the AV 406 and second vehicle 408 approach the parked vehicle 410.

FIG. 4B illustrates a second scenario with a roadway 400 having a left-hand lane 402 and a right-hand lane 404. An autonomous vehicle (AV) 406 is traveling in the left-hand lane 402, and a second vehicle 408 is traveling within the right-hand lane 404. The second vehicle 408 is located forward of the AV 406. Thus, the second vehicle 408 may move in front of the AV 406 at any time, and the AV 406 may continuously assess the lane change considerations. Thus, based upon the lane change considerations no corrective action may be taken or different corrective actions may be taken. The roadway 400 may be a high-speed roadway such as a highway or freeway and the corrective action may be different than if the roadway 400 is a low speed roadway such as a school zone, residential road, industrial road, or a combination thereof. For example, on a highway the first corrective action may be to increase following distance in the event that the second vehicle 408 changes lanes. In a different example, if roadway 400 is an industrial road, the AV 406 may accelerate to overtake the second vehicle 408 so that the second vehicle 408 cannot change lanes. Alternatively, on a low-speed road the AV 406 may slow down to increase following distance so that if the second vehicle 408 changes lanes the AV 406 will be free of a collision or will remail unaffected. Thus, each different scenario may provide different lane change considerations that the AV 406 considers to accurately predict if the second vehicle 408 is likely to change lanes and the AV 406 may take a corrective action accordingly.

FIG. 4C illustrates the roadway 400 comprising an intersection 412. As the AV 406 approaches the intersection 412, the AV 406 may assess vehicles in surrounding intersection lanes, and the likelihood that one or more of the vehicles may cross a path 414 of the AV 406. The AV 406 may first divide the surrounding vehicles into lane change candidates 420 and non-lane change candidates 422. The non-lane change candidates 422 may be vehicles that are behind the AV 406, along a side of the AV 406, will clear the AV 406 before the AV 406 arrives at a location of the non-lane change candidate 422, or a combination thereof. As shown, the non-lane change candidate 422 is expected to clear the intersection before the AV 406 arrives at the intersection 412 so the AV 406 is able to eliminate the vehicle as a candidate for tracking and making a lane change. Once a vehicle is determined to be a non-lane change candidate 422 the vehicle is disregarded in the lane change considerations. The AV 406 after excluding the non-lane change candidates 422 may then generate predictions for the lane change candidates 420.

The predicted paths generated, as shown, comprise a first predicted path 424 and a second predicted path 426. The first predicted path 424 extends in a forward direction maintaining a second vehicle 408 within the second vehicle's 408 original lane. The second predicted path 426 turns through the intersection 412 from a first lane 428 into a second lane 430 that extends in a second direction. The AV 406 may then generate the first predicted path 424 and the second predicted path 426. The AV 406 determines a likelihood that the second vehicle 408 based upon the lane change considerations will maintain movement along the first predicted path 424 or will change lanes into the second predicted path 426. The likelihood that the second vehicle 408 continues along the first predicted path 424 may be determined, to be lower than the likelihood that the second vehicle 408 turns to move along the second predicted path 426. For example, if the AV 406 determines that the second vehicle 408 is slowing down then the lane change considerations may indicate that the second predicted lane 426 is more likely than the first predicted lane 424. Thus, the AV 406 may have a confidence level of around 70 percent that the second vehicle 408 will change to the second predicted lane 426, and the confidence level for continuing along the first predicted lane 424 may be a confidence level of around 60 percent. Accordingly, the corrective actions taken by the AV 406 may be directed towards avoiding the second vehicle 408 along the second predicted path 426 as the second vehicle 408 moves into the second lane 430.

FIG. 4D illustrates the roadway 400 comprising an intersection 412. An autonomous vehicle (AV) 406 is traveling towards the intersection 412 and preparing to take a left-hand turn along the path of travel 414. A second vehicle 408 is driving in a first left-hand lane 402 and is approaching the intersection at a similar time as the AV 406 such that the second vehicle 408 is a lane change candidate 420. The AV 406 (or processor of the AV 406) may predict the possible directions of travel of the second vehicle 408. The second vehicle 408 may have first predicted path 424 within the first left-hand lane 402, and a second predicted path 426 where the second vehicle 408 changes lanes to a second left-hand lane 402′. The AV 406 generates a confidence level that the second vehicle 408 will continue along the first predicted path 424 or will change lanes and travel along the second predicted path 426. The AV 406 may assign a low risk to the second vehicle 408 as changing lanes between the first left-handed lane 402 and the second left-handed lane 402′ may not significantly change a timing of when the second vehicle 408 would cross the path of the AV 406. Given this scenario, the AV 406 may treat the first predicted path 424 and the second predicted path 426 similarly to reduce computation usage, increase prediction speed, or both relative to predicting every scenario for every surrounding vehicle. The AV 406 may simultaneously generate predictions regarding other lane change candidates 402′ such as a third vehicle 416.

The third vehicle 416 may be traveling in first-right hand lane 404. The AV 406 upon detecting the third vehicle 416 may begin to predict possible paths for the third vehicle 416. The third vehicle 416 may have a first predicted path 424′ where the third vehicle 416 continues along the first right-hand lane 404. The third vehicle 416 may have a second predicted path 426′ where the third vehicle 416 may change lanes into a second right-hand lane 404′. The AV 406 may be preparing to make a left-hand turn into the second right-hand lane 404′ such that if the third vehicle 416 remains in the first right-hand lane 404 there is a low likelihood of crossing paths. However, if the third vehicle 416 changes lanes into the second right-hand lane 404′, the chances of the third vehicle 416 and the AV 406 crossing paths increases. The AV 406 determines the likelihood that the third vehicle 416 may change lanes by assessing all of the lane change considerations. The lane change considerations provide a probability that the third vehicle 416 will change lanes into the second right-hand lane 404′ and cross paths with AV 406. Based upon the probability of crossing paths the AV 406 may take a corrective action to avoid the third vehicle 416. The AV 406 may continuously estimate the likelihood that the second vehicle 408, the third vehicle 416, or both will change lanes until there is no longer a possibility of crossing paths. Each predicted path may be assigned a prediction number between 0 and 100 with 0 being no likelihood of lane change and 100 being a high likelihood of a lane change. Depending on the prediction number assigned to each path, different correction actions may be generated. For example, if the predicted number is 0 to 25 then the corrective action may be no corrective action. In another example, if the prediction number is between 25 and 50 the AV 406 may take a corrective action at a lower rate than if the prediction number is above 50 (e.g., reduce a speed of the vehicle by 1 KPH v. 5. KPH). In a third example, if the prediction number is between 50 and 75, some correction action may be taken to reduce the prediction number. In a fourth example, if the predicted number is above 75 then some corrective action may be taken such as speeding up, slowing down, changing lanes, stopping, coasting, changing a distance between the AV and the vehicle of interest, or a combination thereof. The AV 406 will continuously generate prediction numbers until the vehicles of interest are passed, move out of consideration, change to a non-lane change candidate, or a combination thereof.

FIG. 4E illustrates a roadway 400 with two parallel lanes that comprise a left-handed lane 402 and a right-handed lane 404. The AV 406 is traveling in the right-handed lane 404 along path 414. The AV 406 as shown, is traveling directly behind a fourth vehicle 418 that is traveling along the right-hand lane 404. The AV 406 with the lane change consideration generates a likelihood of lane changes. The fourth vehicle 418 is located in the same lane as the AV 406 so the fourth vehicle 418 is considered to be a non-lane change candidate 422 as the fourth vehicle 418 cannot change lanes to be in front of the AV 406.

Simultaneously, before, or after the fourth vehicle 418 is determined to be a non-lane change candidate 422, a lane change analysis may be performed as to the third vehicle 416. The third vehicle 416 is located alongside the AV 406, slightly behind the AV 406, or both. With this information and the lane change considerations, the AV 406 generates a likelihood of lane changes. With the third vehicle 416 being located alongside and even slightly behind the AV 406, the third vehicle 416 may be deemed to be a non-lane change candidate 422 (e.g., a predicted number of 0) since from the present position the third vehicle 416 cannot change lanes to be in front of the AV 406. By eliminating the fourth vehicle 418 and the third vehicle 416 as lane change candidates an amount of computing power may be directed to other vehicles. The AV 406 may simultaneously, before, or after the fourth vehicle 418, the third vehicle 416, or both determine a status of a second vehicle 408.

The AV 406 may generate a lane change likelihood estimation based upon lane change consideration to determine a likelihood that the second vehicle 408 may change lanes. The second vehicle 408 is located in a left-hand lane 402 and is located forward of the AV 406. These lane change considerations indicate that the second vehicle 408 is a lane change candidate 420. If a vehicle is determined to be a lane change candidate, the AV 406 continues to monitor the second vehicle 408 and generate prediction numbers regarding the likelihood that the second vehicle 408 will continue along a first predicted path 424 or will change lanes to travel along a second predicted path 426. As shown, the fourth vehicle 418 is located at least partially aside from the second vehicle 408 such that the likelihood of lane change may be reduced since there is not currently room for the second vehicle 408 between the AV 406 and the fourth vehicle 418. Thus, the prediction number for the first predicted path 426 may be less than the prediction number for the second predicted path 424. However, the AV 406 may take some corrective action to further decrease the prediction number to reduce the likelihood that the fourth vehicle 418 will change lanes in conflict with the AV 406.

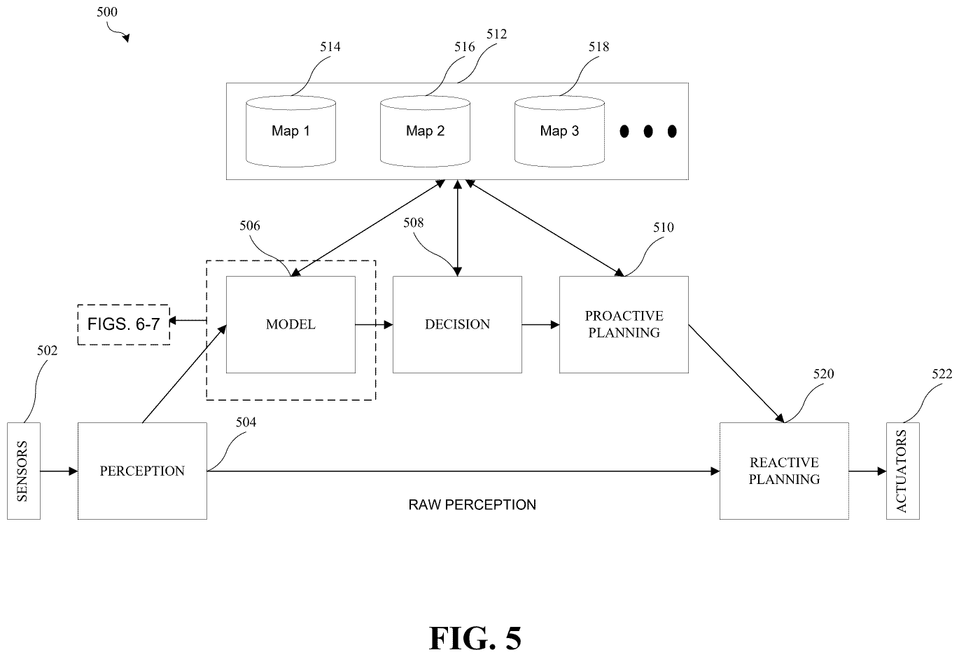

FIG. 5 is a diagram of a world prediction model 500. The world prediction model 500 is capable of reviewing data from sensors 502 and controlling an autonomous vehicle (e.g., AV 406 of FIGS. 4A-4E) based upon the data from the sensors 502 and other considerations. The data from the sensors 502 is stored and processed by a perception 504 portion of a processor (step or device). The perception 504 may generate a raw perception that is immediately transmitted to a reactive planner 520 portion of a processor (e.g., step or device).

The reactive planner 520 may immediately generate a reaction that controls the AV to avoid objects and collisions (including vehicles changing lanes). The reactive planner 520 may control one or more actuators 522 of the AV so that the AV travels within a lane and avoids other objects such as other vehicles. The actuators 522 may control one or more features of the AV such as speed, breaking, steering, or a combination thereof. The raw perception may also be sent from the perception 504 to a model 506 portion of a processor, a decision 508 portion of a processor, a proactive planning 510 portion of a processor, or a combination thereof. The model 506, the decision 508, and the proactive planning 510 may directly communicate with one another or may be in indirect communication with one another (e.g., via a database 512).

The model 506 may generate a plan (e.g., actions) by accessing various other portions of the processor. The model 506 may access maps from the database 512. The database 512 may include a plurality of maps that each convey some information. The database 512 may include a first map 514, a second map 516, a third map 518, or more. The maps 514-518 may include data about roads, lanes, global positions, elevations, a bootstrap map, a historical map, a Sanborn map, a map of a continent that the vehicle is being shipped (e.g., map of Asia, Europe, North America, South America, Antarctica, Africa, Australia), or a combination thereof. The database 512 may assist in placing the AV in a three-dimensional space so that surroundings of the vehicle may be considered as the vehicle travels. The model 506 may use map information to determine a number and location of lanes within a roadway. The model 506 may predict certain actions of the AV as the AV travels along the roadway. Modeling performed by the model 506 portion of the processor may be shared with the database 512, the decision 508 part of the processor, or both.

The decision 508 (e.g., step or device) may generate actions to be taken by the AV. The decision 508 may assist with more than lane changes of surrounding vehicles. However, the decision 508 may track and predict reactions of surrounding vehicles (e.g., lane changes) and then determine control of the AV based on the modeling and decisions. If the modeling shows that a vehicle is a lane change candidate then the AV may take a corrective action as discussed herein. A decision, desired action, lane change estimation, lane change prediction, or a combination thereof may be communicated from the decision 508 to the proactive planning 510.

The proactive planning 510 may provide instructions to the AV in advance of a lane change, if a lane change candidate is identified, or both. The proactive planning 510, may take or suggest one or more corrective actions. The proactive planning 510 may suggest that the AV speed up, slow down, change lanes, move over, maintain speed, coast, brake, move over, coast, or a combination thereof. The proactive planning 510 may generate a predictive action if a predicted number is greater than a predetermined number. The predetermined number may be about 40 or more, 50 or more, 60 or more, or 70 or more. Thus, if the proactive planning 510 determines that the predicted number is equal to or greater to the predetermined number then the proactive planner will provide some action to the reactive planner 520 and ultimately the actuators 522 to avoid a possible lane change. The proactive planning 510 may attempt to move the AV in such a way that a lane change will cause a collision, an overlap, a conflict situation, or a combination thereof. The reactive planning 520 may take actions if the actions taken by the proactive planning 510 does not avoid an adjacent vehicle making a lane change. Both the reactive planning 520 and proactive planning 510 control actuators 522 of the AV to control movement of the AV within the roadway.

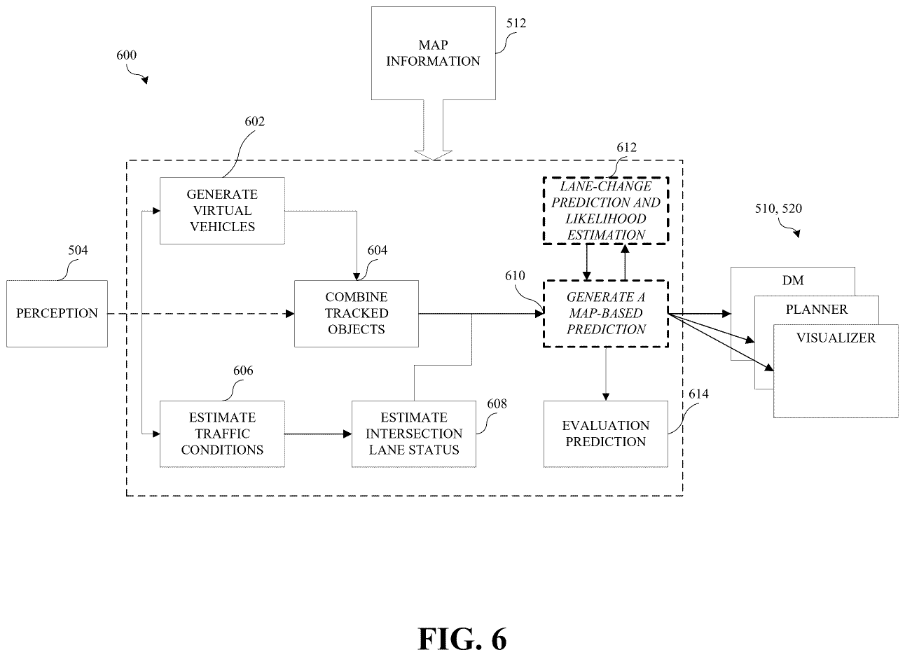

FIG. 6 is a schematic view of the model 506, 600 portion of the model prediction 500 of FIG. 5. The model 506, 600 receives perception data from a perception 504 (of a processor), map information from the database 512 including map information, and then output proactive planning 510 and reactive planning 520 to control the AV based upon a likelihood of lane-change prediction. The proactive planning 510 and the reactive planning 520 control the vehicle based upon likelihood of a lane-change prediction. The perception 504 provides data to generate virtual vehicles 602 of the model 600.

In generating virtual vehicles 602, the model 600 uses sensor data to track and predict where vehicles surrounding the AV are likely to change lanes. The virtual vehicles 602 may assist in generating a possibility of different lane change scenarios of vehicles surrounding the AV. The vehicles around the AV may then be tracked as a virtual vehicle so that the possibility of each lane change may be predicted. Once virtual vehicles are generated 602 the virtual vehicles may be combined as tracked objects 604. The tracked objects may be continuously monitored as the vehicles move around the AV so that lane change predictions may be made as to each of the combined tracked objects 604. The combined tracked objects 604 may then be transmitted to generate a map-based prediction 610.

Generating a map-based prediction 610 may predict a probability of how the surrounding vehicles move within a map containing the AV. Generating the map-based prediction 610 may predict how the vehicles are likely to move along lanes of the map (e.g., or change lanes within the map). Generating a map-based prediction 610 may include a speed of the surrounding vehicles, movement of the surrounding vehicles, traffic patterns, or a combination thereof. Data from generating a map-based prediction 610 is transmitted to a lane-change prediction and likelihood estimation 612 where a prediction and likelihood estimation is generated as to a possibility that each surrounding vehicle may change lanes around the AV.

The lane-change prediction and likelihood estimation 612 may generate a prediction as to a likelihood that each surrounding vehicle may change into a lane in conflict with the AV. The lane-change prediction and likelihood estimation 612 that each vehicle may change lanes into each adjacent lane. For example, if the AV is traveling in a far-right lane out of three lanes and an adjacent vehicle is traveling in the center lane, an estimation may be made as to the likelihood that the adjacent vehicle will stay in the center lane, change into the right lane, or change into the left lane. The lane-change prediction and likelihood estimation 612 generates a number between 0 and 100 (e.g., or a confidence percentage between 0 and 100 percent) as discussed herein as to the likelihood that each adjacent vehicle may change lanes into each lane and specifically may change into a lane of the AV such that the AV may need to take a corrective action. The lane-change prediction and likelihood estimation 612 may use the lane change considerations to provide a likelihood estimation that each surrounding vehicle may change lanes such that each surrounding vehicle may cross a path with the AV or may enter the lane of the AV (e.g., risk a collision with the AV). Once the lane-change prediction and likelihood estimation 612 is generated the data may be passed back to generate a map-based prediction 610 and then to the proactive planning 510 and reactive planning 520 to control the AV and avoid the adjacent vehicles. The model prediction 600 before, during, or after generating virtual vehicles 602 may estimate traffic conditions 606.

Estimating traffic conditions 606 may assist in determining how the traffic patterns will affect the adjacent vehicles. For example, if one lane is more congested than another lane, this congestion may increase a probability that the adjacent vehicle may switch lanes to cross paths with the AV. Estimate traffic conditions 606 may track how each adjacent vehicle moves within the roadway based on the number of lanes, speed of traffic flow, traffic lights, turn offs, or a combination thereof. Estimating traffic conditions 606 may have a different estimation if the traffic is light versus if the traffic is heavy. For example, if the traffic is heavy then a prediction that the adjacent vehicles change lanes or a frequency of lane changes may be higher than if the traffic is light. Heavy traffic versus light traffic may be determined based upon an average speed of the adjacent vehicles, a number of vehicles located on the roadway, how many times the vehicles start and stop over a predetermined distance (e.g., 100 m, 500 m, 1 Km). For example, if a road has a speed limit of 100 Kmph and by monitoring the AV, the AV determines that during light traffic the average speed is around 100 Kmph and during heavy traffic the AV determines that the average speed is around 70 Kmph then the AV may be able to extrapolate how an average speed correlates to an amount of traffic and how an amount of traffic correlates to adjacent vehicle behavior. Once the estimated traffic conditions 606 is determined then the AV (e.g., a processor of the AV) may estimate adjacent vehicle behavior, intersection lane status 608, or both.

The estimation intersection lane status 608 may determine a location of an intersection relative to the AV, a lane of the AV relative to the intersection, a lane of each adjacent vehicle relative to an intersection, or a combination thereof. The estimate intersection lane status 608 may monitor which lane each vehicle is located within as each vehicle approaches the intersection. As each vehicle approaches an intersection, the estimation intersection lane status 608 continuously monitors a position of each vehicle relative to the AV. Once the estimate lane status 608 is determined the data may be transmitted to generate the map-based prediction 610 along with the combine tracked objects 604 in order to generate predictions as to how the vehicles move within the map, along the lanes, or both. Once the processor generates a map-based prediction 610 the lane-change prediction and likelihood estimation 612 may predict the likelihood that adjacent vehicles may change lanes to cross paths with the AV. The lane-change prediction and likelihood estimation 612 and generated map-based prediction 610 data are then provided to an evaluation prediction 614.

The evaluation prediction 614 may assist in predicting how each adjacent vehicle may travel through the lanes in the roadway so that the proactive planning 510 and the reactive planning 520 may avoid crossing paths with the adjacent vehicles at a same time. The evaluation prediction 614 may predict a likelihood of how each adjacent vehicle may move within the roadway, intersection, within lanes, or a combination thereof so that crossing paths at a same time may be avoided between the adjacent vehicles and the AV.

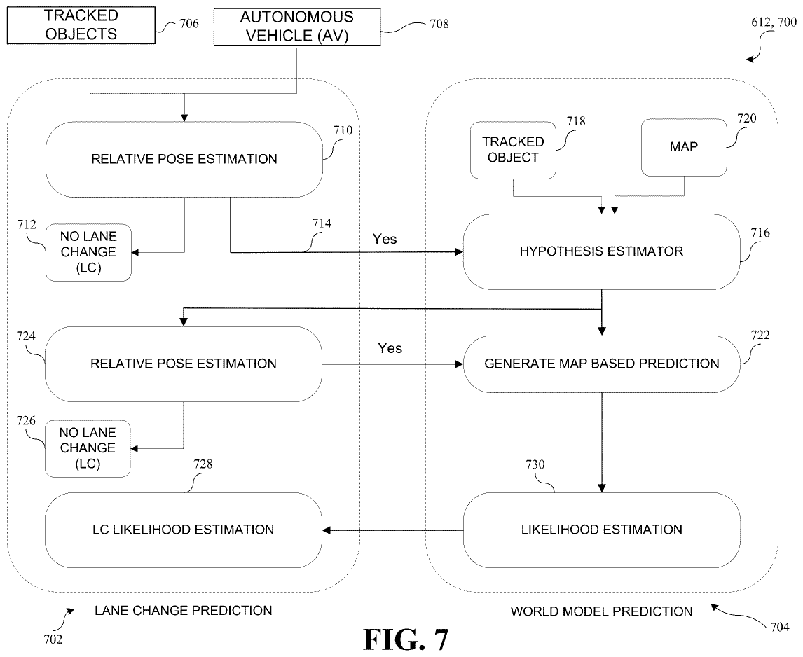

FIG. 7 illustrates a flow diagram of generating a lane change estimation 612 of FIG. 6. The lane change estimation 612, 700 comprises a lane change prediction 702 and a world model prediction 704 that work in conjunction to predict a possibility that a vehicle may change lanes to intersect with a vehicle driving autonomously along a roadway. The lane change prediction 702 tracks and estimates positions of tracked objects 706 and an autonomous vehicle (AV) 708. The lane change prediction 702 uses one or more sensors to track the tracked objects 706 (e.g., adjacent vehicles) and an AV 708 (e.g., the vehicle of interest). The data related to the tracked objects 706 and the AV 708 are transmitted to the lane change prediction 702 so that the data may be analyzed to predict if/when the tracked objects 706 will change lanes relative to the AV 708. The processor has a position that determines a relative pose estimation 710 of the tracked objects 706 and the AV 708.

The relative pose estimation 710 may determine a position one or more tracked objects 706 or a plurality of tracked objects 706. The relative pose estimation 710 may estimate how the tracked objects travel along a roadway. The relative pose estimation 710 may estimate how the AV 708 may travel along the roadway. The relative pose estimation 710 may estimate poses of the tracked objects 706 relative to the AV 708 in order to determine a probably of the tracked objects 706 and the AV 708 crossing paths, colliding, or both by the tracked objects 706 changing lanes. The relative pose estimation 710 may estimate that the tracked objects 706 have no lane change (LC) 712 or yes a LC 714.

If the relative pose estimate 710 determines that there may not be a lane change 712 (e.g., the objects may be a non-lane change candidate). If an object is estimated to have no lane change 712 then further estimation for the tracked object 706 may be ceased until that object becomes a lane change candidate (e.g., the relative pose estimation 710 determines that there is a likelihood of lane change 714).

If it is determined that there is a likelihood of lane change 714 then data is transferred to a hypothesis estimator 716 of the world model prediction 704. In addition to the data from the relative pose estimation 710, data related to tracked objects 718 and data about maps 720 is provided to the hypothesis estimator 716. The hypothesis estimator 716 generates an estimation as to where each of the tracked objects 718 would be located on a map 720 (e.g., a lane within a roadway on the map) or how the tracked objects 718 can travel long the map 720. The hypothesis estimator 716 may generate a hypothesis as to where on the map the tracks objects 718 are estimated to travel within the map 720. The hypothesis generator 716 may estimate a opposition of the tracked objects 706, the AV 708 within a roadway of a map, and then the data may be output to generate map based prediction 722, a relative pose estimation 724, or both.

Generating map-based prediction 722 may predict where or how the tracked objects travel along a roadway of a map 720. The map-based prediction 722 may predict if one or more of the tracked objects 718 may change lanes within the map 720, where the tracked objects 718 may change lanes, if the tracked objects 706 or 718 may cross paths with the AV 708 on the map 720. Generating a map-based prediction 722 may predict how an object changes lanes, where an object changes lanes, or both. Generating a map-based prediction 722 may predict locations where a tracked object 706, 718 may change lanes within a roadway. In conjunction with generating a map-based prediction 722, a relative pose estimation 724 may be considered.

The relative pose estimation 724 may generate a hypothesis as to if each of the tracked objects 706, 718 will change lanes. The relative pose estimation 724 may consider location by location where the tracked objects 718 may be located within the map 720. The relative position estimation 724 determines how a lane change hypothesis is considered. If the relative pose estimation 724 determines that a lane change is not likely 726 or there are not any lane change candidates.

Similar to no lane change 712, no lane change 726 may terminate calculating the probability that a tracked object 706, 718 will change lanes. The objects may continue to be tracked but a likelihood that the tracked object 706, 718 may change lanes will not be calculated. If the relative pose estimation 724 determines that the tracked objects 706, 718 are a lane change candidate then data is returned from the relative pose estimation 724 to the generate map-based prediction 722. The generate map-based prediction 722 determines again or using additional data from the relative pose estimations 724 how the tracked objects 706, 718 would change lanes. Generating map-based predictions 722 then determines a likelihood estimation 730 of how likely the tracked objects 706, 718 are to change lanes to each of the various lanes within a roadway of the map 720.

The likelihood estimation 730 functions to determine if the hypothesis is likely. The likelihood estimation 730 may provide a prediction number on how likely the tracked objects 706, 718 are to change lanes. The likelihood estimation 730 may assign a prediction number on the likelihood that the tracked objects will change lanes. The likelihood estimation 730 may generate the prediction number and the prediction number may be transmitted to a lane change (LC) likelihood estimation 728. The lane change likelihood estimation 728 may determine a confidence level of the likelihood estimation 730. The lane change likelihood estimation 728 may determine how likely the tracked objects 706, 718 are to change lanes into each of the various lanes such that the AV 708 determines a corrective action that may be taken based upon the lane change considerations. If one or more of the lane change considerations 802 are present then the lane change likelihood estimation may be greater, have a higher likelihood, or both.

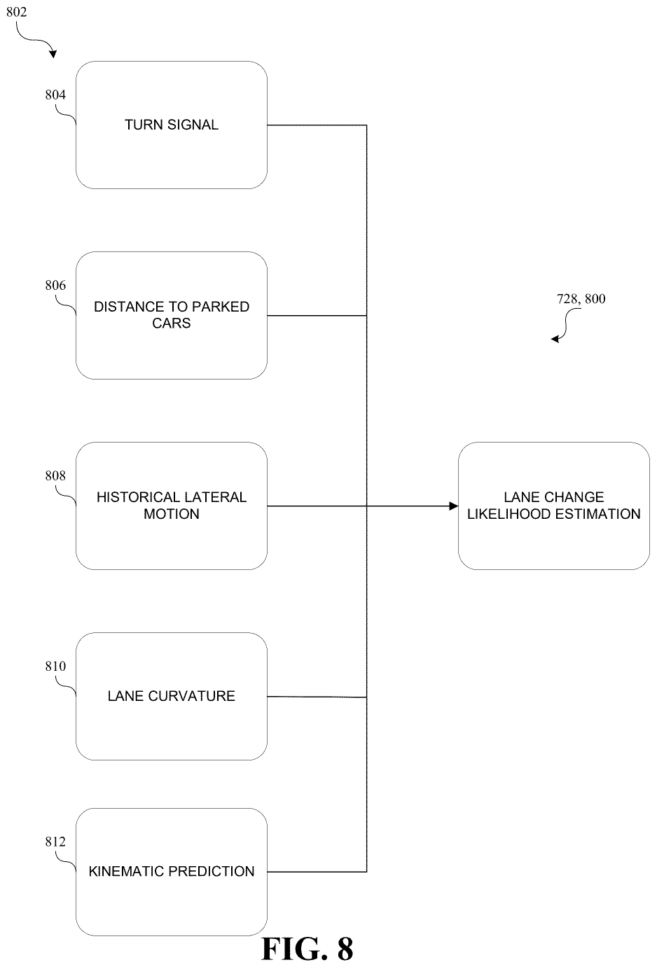

FIG. 8 illustrates generating a lane change likelihood estimation 728, 800 based upon lane change considerations 802. The lane change considerations 802 may be considerations that indicate a likelihood that tracked objects may change lanes. The lane change considerations 802 may include considerations such as a turn signal 804, a distance to parked vehicle 806, historical lateral motion 808, lane curvature 810, and kinematic predictions 812. If one or more of the lane change considerations 802 are present then the lane change likelihood estimation may be greater, have a higher likelihood, or both. For example, if a tracked object uses a turn signal 804 to indicate a lane change then the lane change likelihood estimation may be much higher than if a turn signal 804 is not present.

A lane change likelihood estimation may be determined based upon the turn signal 804. If the tracked object has a right-turn signal activated then the predicted number for the tracked object may be 100 (e.g., a 1) or close to 100. If the tracked object has a left-turn signal activated then the predicted number for the tracked object may be 100 or close to 100. If a turn signal (e.g., right or left) is not present during monitoring then the turn signal component may be assigned 0 as, based upon the turn signal, there is no indication that that the tracked object may change lanes. Once the turn signal 804 monitoring has been determined the processor may consider distances to parked vehicles 806.

The lane change likelihood estimation 800 may monitor for parked vehicles proximate to the AV, the tracked objects, or both. The processor may monitor a distance to the parked vehicle 806, a speed of the AV, speed of the object of interest, is the parked vehicle parked or moving slowly, or a combination thereof. As the object of interest, the AV, or both approach the parked vehicle (e.g., the distance to the parked vehicle 806), the likelihood of a lane change increases (e.g., the predicted number increases) such that the AV may start taking corrective action. If the distance is still large then likelihood may not warrant corrective action. For example, a large distance may be about 2 Km or less, about 1.5 Km or less, about 1 Km or less, about 0.5 Km or less, or even about 0.25 Km or less. A large distance may be about 0.1 Km or more, about 0.2 Km or more, about 0.3 Km or more, about 0.4 Km or more, or about 0.5 Km or more. Thus, for example, if the distance is a large distance then the predicted number may be smaller than if the distance is a small distance. The smaller the distance between the tracked object and the parked vehicle then the higher a predicted number that may be assigned (e.g., a greater the likelihood that the vehicle will change lanes). For example, as the sensors track a distance between the AV or the tracked object and the parked vehicle the higher the predicted number that may be assigned that the object tracked may change lanes. For example, a distance of over 1 Km may be assigned prediction number (e.g., a prediction of a likelihood that the vehicle will change lanes) of 25 or less, a distance between 1 Km and 500 m may be assigned a predicted number of between about 25 and 50, a distance between about 500 m and 250 m may be assigned a predicted number of about 50 to 75, and finally a distance less than 250 m may be assigned a number of 75 or more. Thus, the predicted number may be constantly updated as the AV, the tracked object, or both approach the parked vehicle. Once the distance to a parked vehicle 806 is below a threshold number the AV takes come correction action. As a target object approaches the parked vehicle the target object may partially or fully change lanes, the target object may begin to make a lateral movement, or both.

The sensors may monitor the object of interest and monitor a lane change consideration for the object of interest making historical lateral motions 808. The historical lateral motions 808 may be a location here historically objects of interest move into or towards another lane. The historical lateral motions 808 may be a narrowing of a lane, an ending of a road, ending of a turn lane, or a combination thereof. The historical lateral motions 808 may be based on sensed data, shared data, or both. The historical lateral motions 808 may be a number of times objects of interest have changed lanes the predetermined location in the past predetermined number of instances. For example, the predetermined number of times may be the most recent 1000 times or less, 750 times or less, 500 times or less, 250 times or less, or 200 times or more that the AV or an AV has passed the predetermined location of interest. The historical lateral motions 808 may be based on a set number of counts where an object of interest deviate from their lane (e.g., change lanes). The historical lateral motions 808 may calculate a relative heading of the objects of interest, a distance the object of interest moves when changing lanes, or both. Based upon the number of instances of lane change and headings of the object of interest when a lane change occurs. Based upon the frequency that objects of interest change lanes and the heading of the object of interest upon changing lanes, the lane change consideration may indicate if corrective action is required to avoid the object of interest changing lanes. The historical lateral motions 808 may occur at a change in shape of the road. However, a lane curvature 810 may result in objects of interest partially or entirely moving into another lane.

The lane curvature 810 may result in objects of interest crossing a lane line such that the objects of interest may be considered to partially or completely make a lane change. A likelihood that the object of interest may cross a line or change lanes based upon the lane curvature 810 may change based upon an amount of curvature (e.g., radius or angle) of the lane. The lane curvature 810 may consider a number of curvatures within a predetermined distance. For example, is there a curvature in a first direction and then a second curvature in a second direction (e.g., forming an S). The lane curvature 810 may be a location where objects of interest unintentionally deviate from a lane or heading and make a partial or complete lane change without notice so that the AV may need to factor if an unintentional lane change may occur and corrective action may be needed. The objects of interest may be more likely to deviate from a lane based upon a degree of curvature. The higher the degree of curvature the greater the likelihood that an object of interest may change lanes (e.g., deviate from a lane). Thus, if a lane ahs a 10 degree curvature the likelihood may be greater that a lane change occurs versus a 5 degree lane change. The lane curvature 810 may be one factor of the lane change considerations regarding a possibility of an object of interest changing lanes and kinematic predictions 812 may be another factor to determine a lane change likelihood estimation 728, 800.

The kinematic predictions 812 function to estimate a future motion of an object of interest based upon future motion of the object of interest, speed of the object of interest, or both. The kinematic predictions 812 may take into consideration past locations of the object of interest within a lane, a road, or both. The kinematic predictions 812 may account for a heading angle of the object of interest, if the object of interest is traveling linearly, or both. The kinematic prediction 812 in combination with one or more of the lane change considerations may indicate that corrective action may be needed to avoid a crossing of paths, a collision, or both. I could use a little help with the formulas in the PDF, as most overlay the text. The ones I can read, I do not fully understand. Thus, if we want to include we will need a little clarification.

For simplicity of explanation, the techniques herein are depicted and described as a series of operations. However, the operations in accordance with this disclosure can occur in various orders and/or concurrently. Additionally, other steps or operations not presented and described herein may be used. Furthermore, not all illustrated operations may be required to implement a technique in accordance with the disclosed subject matter.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
tracking an object of interest within a vehicle transportation network;
monitoring lane change considerations related to the object of interest as the object of interest travels through the vehicle transportation network;
predicting a likelihood that the object of interest changes lanes as the object of interest travels within the vehicle transportation network; and
controlling an autonomous vehicle (AV) adjacent to the object of interest to take corrective action based upon a probability that the object of interest is going to change lanes.

2. The method of claim 1, wherein the AV determines if the object of interest is a lane change candidate or a non-lane change candidate.

3. The method of claim 2, wherein the AV is free of performing a step of calculating a likelihood that the object of interest changes lanes if the object of interest is determined to be a non-lane change candidate.

4. The method of claim 1, further comprising:
determining a confidence that the object of interest will change lanes based upon the predicting a likelihood that the object of interest changes lanes.

5. The method of claim 1, further comprising:
generating a predicted number, with a processor, that correlates how likely the object of interest is to changing lanes so that the corrective action taken corresponds to the predicted number.

6. The method of claim 1, wherein the lane change considerations comprise:
detecting a turn signal, detecting a parked vehicle and a distance to the parked vehicle, recalling historical lateral motions, identifying lane curvatures, monitoring kinematic predictions, or a combination thereof.

7. The method of claim 6, wherein upon detecting the turn signal of the object of interest the AV determines that a probability that the object of interest is going to change lanes is percent.

8. The method of claim 1, further comprising:
determining if the autonomous vehicle is approaching an intersection as a step of monitoring the lane change considerations.

9. An apparatus, comprising:
a memory; and
a processor configured to execute instructions stored in the memory to:
track an object traveling within a vehicle transportation network;
monitor lane change considerations related to the object of interest as the object of interest travels through the vehicle transportation network;
predict a likelihood that the object of interest changes lanes as the object of interest travels within the vehicle transportation network; and
control an autonomous vehicle (AV) adjacent to the object of interest to take corrective action based upon a probability that the object of interest is going to change lanes.

10. The apparatus of claim 9, wherein the processor is configured to determine if the object of interest is a lane change candidate or a non-lane change candidate.

11. The apparatus of claim 10, wherein the processor is free of performing a step of calculating a likelihood that the object of interest changes lanes if the object of interest is determined to be a non-lane change candidate.

12. The apparatus of claim 9, wherein the processor determines a confidence that the object of interest will change lanes based upon the predicting a likelihood that the object of interest changes lanes.

13. The apparatus of claim 12, wherein the processor, based upon the confidence, generates a predicted number that correlates how likely the object of interest is to changing lanes so that the corrective action taken corresponds to the predicted number.

14. The apparatus of claim 13, wherein a larger the predicted number a larger the corrective action taken.

15. The apparatus of claim 9, wherein the lane change considerations comprise: a turn signal, a parked vehicle and a distance to the parked vehicle, historical lateral motions, lane curvatures, kinematic predictions, or a combination thereof.

16. A non-transitory computer-readable medium storing instructions operable to cause one or more processors to perform operations to:
track an object traveling within a vehicle transportation network;
monitor lane change considerations related to the object of interest as the object of interest travels through the vehicle transportation network;
predict a likelihood that the object of interest changes lanes as the object of interest travels within the vehicle transportation network; and
control an autonomous vehicle (AV) adjacent to the object of interest to take corrective action based upon a probability that the object of interest is going to change lanes.

17. The non-transitory computer-readable medium of claim 16, wherein the one or more processors are configured to determine if the object of interest is a lane change candidate or a non-lane change candidate.

18. The non-transitory computer-readable medium of claim 17, wherein the one or more processors are free of performing a step of calculating a likelihood that the object of interest changes lanes if the object of interest is determined to be a non-lane change candidate.

19. The non-transitory computer-readable medium of claim 16, wherein the one or more processors determine a confidence that the object of interest will change lanes based upon the predicting a likelihood that the object of interest changes lanes.

20. The non-transitory computer-readable medium of claim 19, wherein the processor, based upon the confidence, generates a predicted number that correlates how likely the object of interest is to changing lanes so that the corrective action taken corresponds to the predicted number, and a larger the predicted number a larger the corrective action taken.
